(19) United States
(12) Patent Application Publication
(10) Pub. No.: US 2019/0290532 A1
(43) Pub. Date: Sep. 26, 2019

(54) Bodily Massage System

(71) Applicant: Carolyn Winston, Bastrop, TX (US)

(72) Inventor: Carolyn Winston, Bastrop, TX (US)

(21) Appl. No.: 15/925,769

(22) Filed: Mar. 20, 2018

(51) Int. Cl. A61H 7/00; A61H 11/00

(52) U.S. Cl. CPC A61H 7/002; A61H 11/00; A61H 2203/0431; A61H 2201/1695; A61H 2201/0149

(57) ABSTRACT

A bodily massage system for PURPOSE includes a vehicle has a seat. The seat has a backrest. A strap is selectively coupled around the backrest. A plurality of cones is provided. A selected one of the cones is slidably coupled to the strap. The selected cone engages a user when the user sits in the seat. Thus, the selected cone massages the user's back.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to massage devices and more particularly pertains to a new massage device for providing a back massage in a vehicle.

### BRIEF SUMMARY OF THE INVENTION

An embodiment of the disclosure meets the needs presented above by generally comprising a vehicle has a seat. The seat has a backrest. A strap is selectively coupled around the backrest. A plurality of cones is provided. A selected one of the cones is slidably coupled to the strap. The selected cone engages a user when the user sits in the seat. Thus, the selected cone massages the user's back.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a bodily massage system according to an embodiment of the disclosure.

FIG. 2 is a bottom view of a cone of an embodiment of the disclosure.

FIG. 3 is a top view of a cone of an embodiment of the disclosure.

FIG. 4 is a right side view of cone of an embodiment of the disclosure.

FIG. 5 is a perspective in-use view of an embodiment of the disclosure.

FIG. 6 is a perspective view of an alternative embodiment of the disclosure.

### DETAILED DESCRIPTION OF THE INVENTION

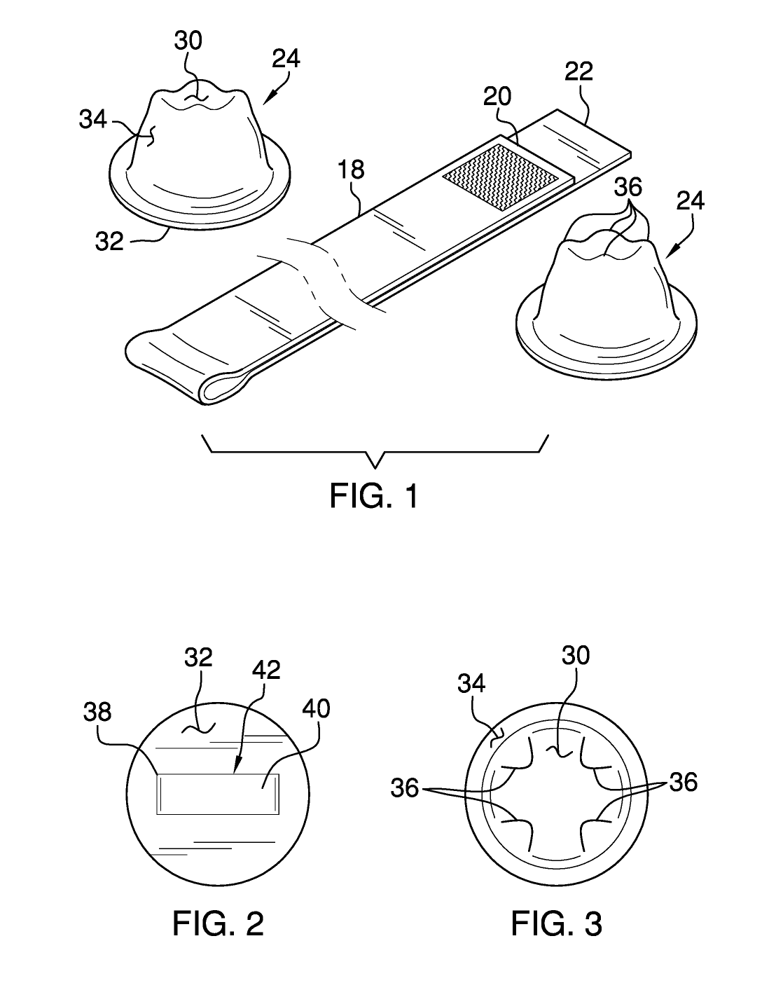

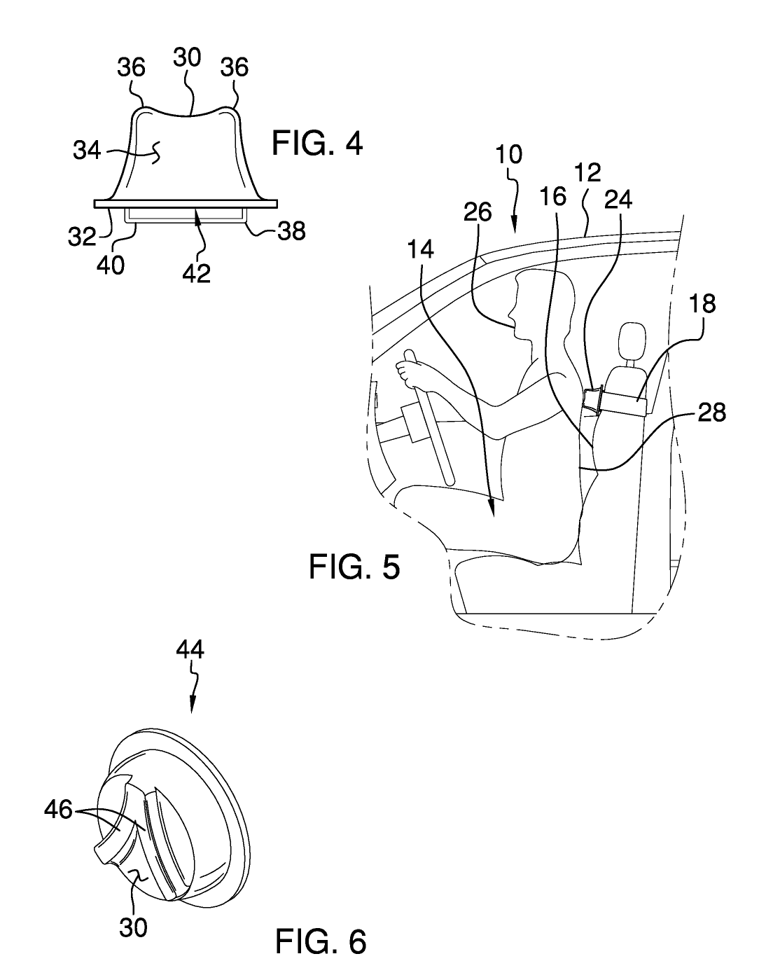

With reference now to the drawings, and in particular to FIGS. 1 through 6 thereof, a new massage device embodying the principles and concepts of an embodiment of the disclosure and generally designated by the reference numeral 10 will be described.

As best illustrated in FIGS. 1 through 6, the bodily massage system 10 generally comprises a vehicle 12 that has a seat 14. The seat 14 has a backrest 16. The vehicle 12 may be a passenger vehicle 12 or the like. Additionally, the vehicle 12 may be a semi tractor.

A strap 18 is provided and the strap 18 is selectively coupled around the backrest 16. The strap 18 has a first end 20 and a second end 22. Each of the first end 20 and the second end 22 is matable such that the strap 18 is retained on the backrest 16. The strap 18 is positioned at a selected height on the backrest 16. A first coupler may be coupled to the strap 18 and the first coupler may be aligned with the first end 20. A second coupler may be coupled to the strap 18 and the second coupler may be aligned with the second end 22. Each of the first and second couplers may be complementary hook and loop fasteners or the like.

A plurality of cones 24 is provided. A selected one of the cones 24 is slidably coupled to the strap 18. Thus, the selected cone may engage a user 26 when the user 26 sits in the seat 14. Thus, the selected cone massages the user's back 28.

Each of the cones 24 comprises a first surface 30, a second surface 32 and an outer surface 34 extending therebetween. The first surface 30 has a plurality of protrusions 36. The protrusions 36 are spaced apart from each other and are distributed on the first surface 30. Thus, each of the protrusions 36 massages the user's back 28 when the user 26 sits in the seat 14.

A bridge 38 is provided. The bridge 38 is coupled to the second surface 32. The bridge 38 has a central portion 40. The central portion 40 is spaced from the second surface 32 to define a slot 42 between the bridge 38 and the second surface 32. The strap 18 is extended through the slot 42. In an alternative embodiment 44 as shown in FIG. 6, a pair of ridges 46 may be positioned on the first surface 30. Each of the ridges 46 may intersect to form a V-shape.

In use, the strap 18 is extended through the slot 42 of a selected one of the cones 24. The strap 18 is wrapped around the backrest 16. The first end 20 of the strap 18 is mated to the second end 22 of the strap 18. The strap 18 is positioned at a selected height on the backrest 16. The strap 18 is positioned adjacent to the seat 14 to facilitate the selected cone 24 to massage lower back muscles. The strap 18 is spaced from the seat 14 to facilitate the selected cone 24 to massage upper back muscles. The selected cone 24 relieves muscle tension and muscle pain associated with driving.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bodily massage system comprising:
a vehicle having a seat, said seat having a backrest;
a strap being selectively coupled around said backrest; and
a plurality of cones, a selected one of said cones being slidably coupled to said strap wherein said selected cone is configured to engage a user when the user sits in said seat thereby facilitating said selected cone to massage the user's back.

2. The system according to claim 1, wherein said strap having a first end and a second end, each of said first end and said second end being matable such that said strap is retained on said backrest.

3. The system according to claim 1, wherein each of said cones comprises a first surface, a second surface and an outer surface extending therebetween, said first surface having a plurality of protrusions, said protrusions being spaced apart from each other and being distributed on said first surface wherein each of said protrusions is configured to massage the user's back.

4. The system according to claim 3, further comprising a bridge being coupled to said second surface, said bridge having a central portion, said central portion being spaced from said second surface to define a slot between said bridge and said second surface, said strap being extended through said slot.

5. A bodily massage system comprising:
a vehicle having a seat, said seat having a backrest;
a strap being selectively coupled around said backrest, said strap having a first end and a second end, each of said first end and said second end being matable such that said strap is retained on said backrest; and
a plurality of cones, a selected one of said cones being slidably coupled to said strap wherein said selected cone is configured to engage a user when the user sits in said seat thereby facilitating said selected cone to massage the user's back, each of said cones comprising:
a first surface, a second surface and an outer surface extending therebetween, said first surface having a plurality of protrusions, said protrusions being spaced apart from each other and being distributed on said first surface wherein each of said protrusions is configured to massage the user's back, and
a bridge being coupled to said second surface, said bridge having a central portion, said central portion being spaced from said second surface to define a slot between said bridge and said second surface, said strap being extended through said slot.
